(19) United States
(12) Patent Application Publication
(10) Pub. No.: US 2002/0178445 A1
(43) Pub. Date: Nov. 28, 2002

(54) Subscriber selected advertisement display and scheduling

(76) Inventors: Charles Eldering, Doylestown, PA (US); Komlika K. Gill, Cherry Hill, NJ (US); Gregory C. Flickinger, Furlong, PA (US)

Correspondence Address: EXPANSE NETWORKS, INC., 300 NORTH BROADSTREET, DOYLESTOWN, PA, 18901, US

(21) Appl. No.: 10/116,669

(22) Filed: Apr. 3, 2002

Related U.S. Application Data
(60) Provisional application No. 60/281,196, filed on Apr. 3, 2001.

(51) Int. Cl. H04N 7/025; H04N 7/10; G06F 17/60

(52) U.S. Cl. 725/32; 705/14

(57) ABSTRACT

A subscriber selected ad display and scheduling system which allows subscribers to request any one of a plurality of advertisements they wish to view from a library of advertisements stored at the set-top box. Generally, the set-top box stores a plurality of advertisements that have been targeted to the subscriber. Two different embodiments are provided. In one embodiment, the subscriber may view different available advertisements via an advertisement guide, and select one or more advertisements wherein upon selection, the contents of the selected advertisements are immediately displayed at the subscriber display. Alternatively, the subscriber may select one or more advertisements from a list of advertisements with the help of an advertisement guide. In this embodiment, the selected advertisements are scheduled for displays, i.e., as soon as the next avail (advertisement opportunity) is identified, the next selected advertisement is inserted in the avail.

### CROSS-REFERENCES

This application claims priority under 35 U.S.C. §119(e) for Provisional application Nos. 60/281,196 (Docket No. T740-00) filed on Jan. 9, 2002 that is herein incorporation by reference in its entirety, but is not admitted to be prior art.

This application is related to all of the Applicants co-pending applications, patents and publications listed below. Each item listed below is herein incorporated by reference in its entirety but is not admitted to be prior art:

U.S. application Ser. No. 09/204,888, filed on Dec. 3, 1998 entitled “Subscriber Characterization System” (Docket No. T702-00);

U.S. patent application Ser. No. 09/516,983, filed on Mar. 1, 2000 entitled “Subscriber Characterization with Filters” (Docket No. T702-02);

U.S. patent application Ser. No. 09/591,577, filed on Jun. 9, 2000 entitled “Privacy-Protected Advertising System” (Docket No. T702-03);

U.S. patent application Ser. No. 09/635,252, filed on Aug. 9, 2000 entitled “Subscriber Characterization Based on Electronic Program Guide Data” (Docket No. T702-04);

U.S. patent application Ser. No. 09/857,256 filed on Jun. 1, 2001 entitled “Subscriber Characterization and Advertisement Monitoring System” (Docket No. T702-15);

U.S. application Ser. No. 09/205,653, filed on Dec. 3, 1998 entitled “Client-Server Based Subscriber Characterization System” (Docket No. T703-00);

U.S. application Ser. No. 09/205,119, filed on Dec. 3, 1998 entitled “Advertisement Monitoring System” (Docket No. T704-00);

PCT Application PCT/US01/06459 (WIPO Publication WO 01/65747A1), filed on Mar. 1, 2001 entitled “Advertisement Monitoring and Feedback System” (Docket No. T704-01PCT);

U.S. application Ser. No. 09/452,893, filed on Dec. 2, 1999 entitled “Subscriber Identification System” (Docket No. T705-01);

U.S. application Ser. No. 09/857,160, filed on Jun. 1, 2001 entitled “Subscriber Identification System” (Docket No. T705-13);

U.S. patent application Ser. No. 09/635,542, filed on Aug. 10, 2000 entitled “Grouping Subscribers Based on Demographic Data” (Docket No. T719-00);

U.S. patent application number unknown filed on Oct. 31, 2001 entitled “Profiling and Identification of Television Viewers” (Docket No. T734-10);

U.S. patent application Ser. No. 09/928,024 on Aug. 10, 2001 entitled “Targeting Ads to Subscribers based on Privacy Protected Subscriber Profiles” (Docket No. T741-10); and

PCT Application PCT/US01/25261, filed on Aug. 10, 2001 entitled “Targeting Ads to Subscribers based on Privacy Protected Subscriber Profiles” (Docket No. T741-10PCT).

### BACKGROUND OF THE INVENTION

Advertising plays an important role in traditional broadcast television in that a significant percentage of broadcast television content is paid for by advertising dollars. Advertisers pay large sums of money to place their advertisements in programs that are then transmitted to subscribers who pay nothing for the programming. Production costs for coverage of sporting events, sit-coms, talk shows and a variety of other types of programs are covered by advertising revenues.

Advertisement sponsored programming is also transmitted over cable and satellite networks, and although those subscribers pay a subscription fee, the retransmitted broadcast material is still advertisement sponsored.

Television advertising is not inherently selective, and although an advertisement can be placed in a program which has been made for an audience with somewhat specific market characteristics, it is in general difficult to target traditional television advertising. For example, an advertisement about a product for male hair growth would typically be directed to males because males are more likely to purchase the product. The proportion of the audience which is thought to be genuinely interested in the advertisement (or believed by the advertiser to be a prime candidate to purchase their product) varies by product category, but normally ranges from 20-40%. Therefore, the advertisement viewed by the other 60-80% of the audience, which are not prime candidates, represents a large amount of wasted spending by the advertiser.

Another problem which traditional television faces is the advent of digital storage devices and on-demand video systems which allow the viewer to skip advertisements by fast-forwarding through them or deleting them altogether. Although subscribers have had the ability to fast-forward through advertisements in recorded materials in Video Cassette Recorders (VCRs) for years, the advent of digital storage systems including Personal Video Recorders (PVRs) and Video on Demand (VoD) systems will greatly enhance the ability of the subscriber to ignore advertisements entirely.

Nevertheless, advertisements have an entertainment and educational value, and subscribers frequently watch them, and in some instances look forward to advertisement campaigns from certain manufacturers. In the broadcast environment a subscriber can expect to see advertisements at particular times, but has no control over which advertisements are shown. In a digital storage on-demand environment the subscriber could potentially choose to watch advertisements.

What is needed is a method and system for displaying and scheduling advertisements which results in which advertisements which are better suited to the viewer being selected and viewed by those viewers.

### SUMMARY OF THE INVENTION

The present invention encompasses a method and system for displaying and scheduling advertisements which allows a viewer to select advertisements of interest and view them, either on an on-demand basis or inserted into advertising opportunities (“avails”) which occur in broadcast programming and retransmitted broadcast programming.

In one embodiment of the present invention, the subscriber is presented a selection of advertisements in an advertisement guide menu, and selects which advertisements or types of advertisements, are of interest. The advertisements are scheduled for display. Typical scheduling includes immediate playback (e.g. advertisements on demand) or insertion of the selected advertisements in the advertising opportunities (e.g. avails) in the program stream.

The advertisements can be stored in a wide variety of locations and on different media including local storage in the PVR, head-end storage, or network storage (e.g. elsewhere in the network or on a remote server).

Targeting is accomplished in part by having the subscriber select the advertisements that are of interest to him/her. Additional targeting is accomplished by selecting the advertisements which are likely to be of interest to the subscriber and presenting those options on the advertisement guide menu. Targeting can be accomplished by using one or more market segmentation techniques and filtering out those advertisements which do not fit the market segments the subscriber is in. Advertisements which do not fit the prescribed market segments can be discarded (not stored) or are not displayed as options on the advertisement guide menu. Alternatively, the market segments can be displayed to the subscriber, who can select a particular segment and subsequently choose the advertisements of interest.

One advantage of the present invention is that it allows for subscribers to pick advertising that they believe is of interest, relevant, or simply entertaining, and view that advertising either immediately or during traditional commercial breaks. This will result in extremely high value advertising reaching the appropriate consumers and allows the traditional broadcast advertising model to continue.

Another advantage of the present invention is that it allows advertisers to target their advertisements by selectively storing and/or presenting those advertisements according to market segment. By presenting choices for advertising which are constrained to a particular market segment, the subscriber is more likely to find ads of interest.

By creating ways to allow subscribers to select ads which are potentially of interest the present invention solves the problems associated with the skipping of advertisements in video systems having digital storage capabilities.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 is a block diagram of an exemplary television service communication network;

FIG. 2 is a block diagram of an exemplary set-top box of FIG. 1;

FIG. 3 illustrates ad channels being sent on low-moderate bandwidth channels, both at constant bit rates and variable bit rates;

FIGS. 4A-4C illustrate how an ad channel could be transported to a Set-Top Box (STB) according to different broadband service and delivery platforms;

FIG. 5 illustrates an exemplary menu associated with the client application running at the STB;

FIG. 6 illustrates another exemplary menu in which the advertisements are listed in different categories;

FIG. 7 illustrates an exemplary menu in which the advertisements are listed via the advertisers;

FIG. 8 illustrates the functionality associated with one embodiment of the present invention;

FIG. 9 illustrates the functionality associated with another embodiment of the present invention; and

FIG. 10 is a functional block diagram illustrating advertisement insertion according to one embodiment of the present invention.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

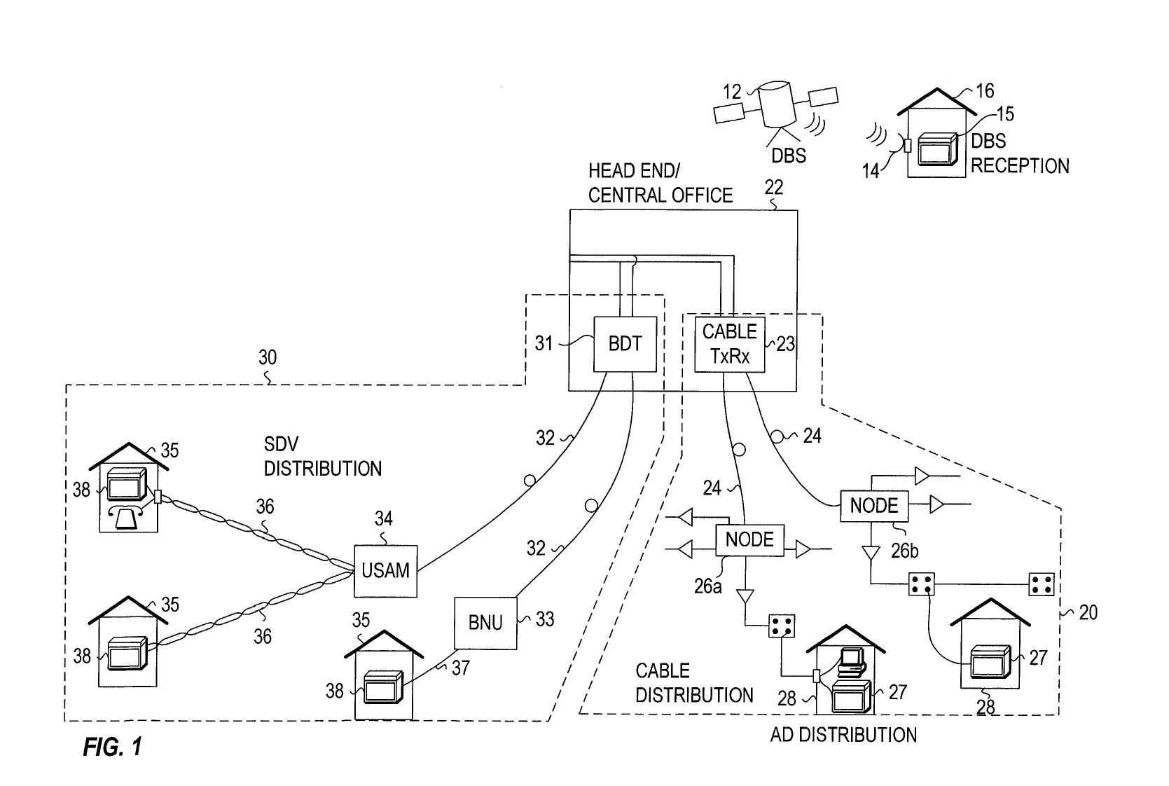

With reference to the drawings, in general, and FIGS. 1 through 10 in particular, the apparatus of the present invention is disclosed.

FIG. 1 illustrates three types of digital television service delivery networks including a} digital cable; b} Digital Broadcast Satellite (DBS); and c} Very high speed Digital Subscriber Line (VDSL).

In a typical digital cable network 20, multiple channels of television information are transmitted from a head end or central office 22 via a cable network 23. Particularly, the channels are transmitted via cables 24 to nodes 26. The nodes are essentially switching/routing stations which service multiple homes (usually a few hundred). The nodes 26 route the signals to individual subscribers 28. The individual subscribers will have set-top boxes 27 that select a particular channel from the transmit stream, demodulate it and forward it for display on one or more monitors or televisions (not shown). Upstream information may be sent from the set-top box to the central office via a dedicated upstream channel over the cable. In cable systems that do not support two-way communication, the upstream “channel” can be through the telephone as described above in connection with DBS systems.

In a digital broadcast satellite system, a programming stream comprising upwards of a hundred channels of television programming is delivered directly from a geo-stationary satellite transmitter 12 orbiting the earth to a receiving antenna 14 mounted on or near each subscriber's house and from the antenna via a cable to a satellite receiving station 15 in the subscriber's house 16. The satellite receiving station 15 (which is a form of set-top box) selects a channel and demodulates the signal for delivery to a monitor (e.g., a television, not shown). Most DBS systems are arranged such that data also can be sent in the upstream direction, that is, from the set-top box 15 to the DBS provider. In most DBS systems, the set-top box also is coupled to the telephone line and is designed and programmed to place telephone calls to the DBS service provider to periodically send information in the upstream direction. Such information commonly may comprise requests for Pay-Per-View programs or requests for changes in the subscription (e.g. a request that one or more premium channels be added to the service).

In accordance with a third common type of system, namely, Switched Digital Video (SDV) 30, television programming is transmitted over a telephone type point-to-point network such as a VDSL network. Particularly, television signals are transmitted from a broadband digital terminal (BDT) 31 via wire, typically fiber optic cable 32, to a universal service access multiplexer (USAM) 34 which then delivers the data to multiple individual subscriber households 35 via regular telephone twisted wire pair 36 using VDSL modems and protocols.

The USAM 34 receives a wide bandwidth signal comprising some or all of the television channels. However, because of the bandwidth limitations of twisted pair wire, typically only about one channel of television programming at a time can be delivered from the USAM to the household. Accordingly, the subscriber has a set-top box 38 that is similar in functionality to the set-top box of a digital cable system or DBS system, except that when the subscriber changes channels such as by operating a remote control, the remote channel change signal is received by the STB and transmitted to the USAM 34 which switches the channel for the subscriber and begins sending the newly selected channel to the household. SDV systems are essentially fully modern asynchronous two-way communication networks. Accordingly, the set-top box can transmit information upstream via the same VDSL modem that receives the downstream signals. SDV systems typically operate using an asynchronous transfer mode (ATM) protocol which is well-known in the networking arts. Fiber based networks such as Fiber to the Curb (FTTC) or Fiber to the Home (FTTH) can also be used for SDV.

Video programming can also be delivered over the Internet in a streaming media or other format and received on a personal computer or television through a STB with the appropriate interface. The video programming can be transmitted over an Internet based television type broadcast system or as part of an on-demand service.

Although the transmission format on any of these networks can be based on the Motion Pictures Expert Group (MPEG) video format the invention imposes no constraints on the types of video encoding and compression that can be utilized.

All of the aforementioned networks can support Video on Demand (VoD) programming in which a subscriber chooses a particular program and watches that program either immediately or within a short time period (e.g. 10-20 minutes). Although VoD has been typically viewed as pay service which is not advertising supported, there are now business models in which the subscriber does not pay for the VoD program but simply watches advertisements to “pay” for the programming.

VoD systems are well known to those skilled in the art and can be implemented on any 1 of the aforementioned networks by utilizing storage (at the STB, head-end, or elsewhere in the network) to allow the subscriber to selectively playback the programming.

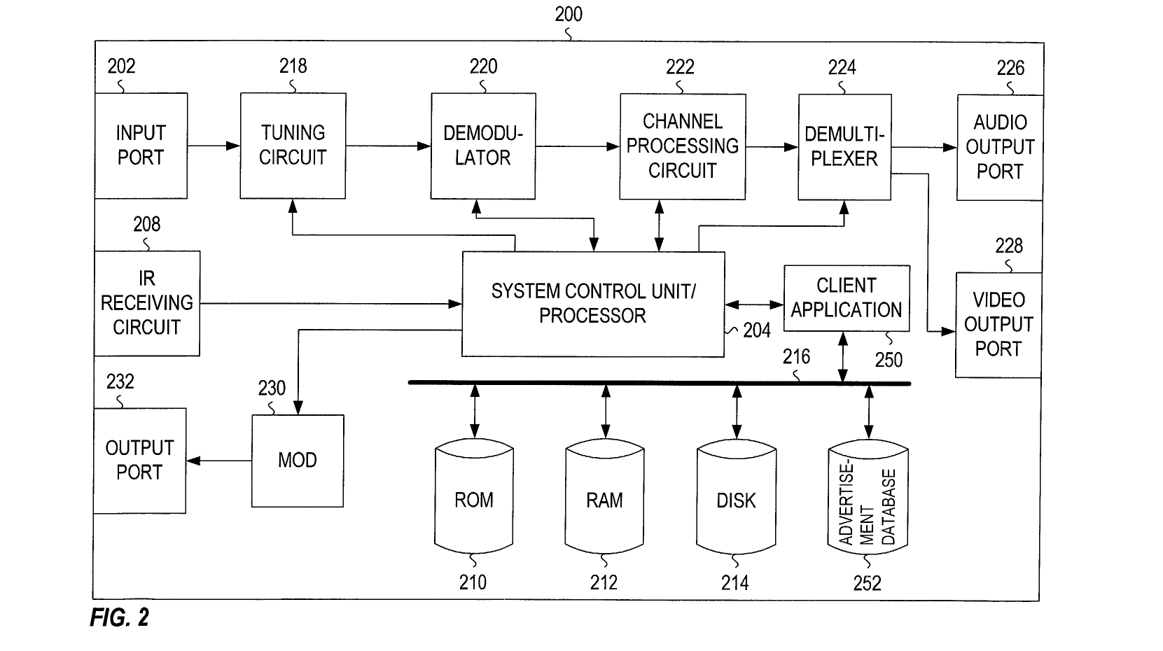

FIG. 2 is a block diagram showing the basic components of a typical set-top box 200 within which the present invention may be incorporated, whether it is for DBS, SDV, digital cable or any other system. The set-top box 200 includes an input port 202 for coupling to the input signal, e.g., a coaxial cable in the case of analog or digital cable TV, a telephone line in the case of SDV or an input cable from an antenna in the case of DBS. The television input signal may be analog or digital.

The STB includes a system control unit/processor 204 which controls the operation of the components of the STB. The system control unit/processor 204 essentially is a Central Processing Unit (CPU) and may be any Digital Processing Device, such as a microprocessor, Finite State Machine (FSM), Digital Signal Processor (DSP), Application Specific Integrated Circuit (ASIC), or general purpose computer.

The system control unit/processor 204 receives commands from the subscriber, such as through infrared (IR) reception of commands from a handheld remote control unit (not shown) through an IR receiving circuit 208, decodes the commands and forwards control signals to other circuits in the set-top box 200 in order to carry out the subscriber's commands, such as changing the channel. The STB further includes a read only memory (ROM) 210 containing software and fixed data used for operating the STB, and a random access memory (RAM) 212 for storing changeable data.

The STB may also include a separate internal or external memory device, such as a hard disk drive 214 or optical disk drive for storing the data that comprise digital multimedia data, e.g., television programs and advertisements. Addition of mass storage can result in the STB serving as a Personal Video Recorder (PVR) which has the basic functionality of a Video Cassette Recorder (VCR) along with a host of additional digital based features.

When used herein the term “on-demand” refers to any type of entertainment system in which programming and advertisements can be played on demand. This includes but is not limited to VoD systems and PVRs with local, head-end, or network storage. What is common to all of the on-demand systems is that the advertisements can be stored and recalled for playback, either immediately, in a sequence, or scheduled for insertion into a program.

The SCU/processor 204, RAM 212, ROM 210 and hard disk 214 are coupled to a master bus 216 over which the units can communicate with each other.

The input signal from input port 202 is passed through a tuning circuit 218. Under control of the system control unit/processor 204, the tuning circuit selectively parses out the data corresponding to the particular channel selected by the viewer. That data is passed to a demodulator 220 that demodulates the data. A channel processing circuit 222 takes the demodulated channel data and processes it as needed. The necessary channel processing may be very simple or may comprise significant processing of the data depending on the particular form of the input data and the features of the STB. The required channel processing is well understood by those skilled in the art. Exemplary functions that might be performed in the channel processing circuitry include decoding an encoded data stream (e.g., MPEG, Dolby SurroundSound) or inserting advertisements into the data stream in accordance with the present invention.

For the insertion of advertisements, cue tones can be utilized. Digital cue tones are specified in the Society of Cable and Television Engineers (SCTE) DVS-253 specification and the related DVS-380 messaging specification.

If received data is to be stored locally at the STB, the channel processing circuit can pass the data to one of the memory devices 212 or 214 through the system control unit/processor 204.

An advertisement database 252 can also be coupled to the master bus 216, wherein the advertisement database 252 comprises the targeted advertisements directed at the STB 200 It is to be noted that the targeted advertisements may be pre-loaded in the advertisement database 252 or may be delivered to the STB 200 via various different means (described later in detail). Within the advertisement database, the advertisements may be identified by unique identifiers (AD_IDs).

The output of the channel processing circuit typically is coupled to a demultiplexer 224 which separates the audio and video portions of the channel and forwards them to audio and video output ports 226 and 228, respectively.

Tuning circuit 218 and channel processing circuit 222 may be controlled by the system control unit/processor 204. However, the demodulator and demultiplexer may also need control.

Many STBs also can transmit data upstream to the head end. Such STBs would include a modulator 230 coupled to the system control unit for modulating data generated in the system control unit/processor 204 for transmission to the head end as well as an output port 232 for coupling a cable or other link to the head end. It will be understood by those skilled in the art that the input port 202 and output port 232 might comprise the same physical port.

The system control unit/processor 204 is also coupled to client application module 252 wherein the client application module 250 may be a software module. The client application module 250 is capable of receiving information from the advertisement database 250 and creating an advertisement guide, the advertisement guide presenting a list of available advertisements in a user-friendly graphical interface. The list of advertisements may be provided in a variety of different ways. Some of the exemplary formats are described in detail later.

Although FIG. 2 provides one example of a STB, other forms of STBs are possible including distributed STBs, residential gateways, personal computer based STBs, and other units used to receive and decode analog and digital video signals.

The present invention supports the targeting of advertisements through a variety of mechanisms including market segmentation techniques. The actual formation of groups for targeted advertising can be accomplished by creating multiple lists or tables (subgroups) of subscribers that share one or more subscriber characteristics. The subgroups may be based on (1) geographic segmentation, (2) demographic segmentation, (3) psychological segmentation, (4) psychographic segmentation, (5) sociocultural segmentation, (6) use-related segmentation, (7) use-situation segmentation, (8) benefit segmentation, and (9) hybrid segmentation. More information may be found in a book entitled Consumer Behavior, by Leon G. Schiffinan and Leslie Lazar Kanuk published by Prentice Hall, New Jersey 1999.

The analysis of different segmentations permit the advertisement to be directed to specific subscribers or groups of subscribers who fit certain criteria. For instance, an advertisement for a baby stroller could reach parents of children under five years old—and only those individuals in that group. Information to place subscribers in the appropriate market segments can be obtained from a variety of public and private sources. Additionally, subscribers may be better understood through their interactions with the television or their purchases (either through the television or through a store). Data from a large number of sources may be mined to form a subgroup of subscribers which has a common characteristic2 which matches the characteristics of the target group.

One technique for forming groups involves the utilization of geographic location information. Each group may consist of subscribers located in a particular state or city, or who may be associated with a cable television node. Another technique for forming groups is based on knowledge of the viewership of the actual programming. For example, many companies collect data related to the viewing of the television programming and such information may be used to form subgroups. Once such collection of data, known as the Nielsen ratings, are based on samples of information related to the viewing of television programming. Other types of similar information are also available. The groups may be based on the actual viewership information, on an estimate of the current viewership, or on the statistical measurement of the viewership.

Formation of groups and market segments is one step towards “perfect” or one-to-one targeting. One way to form groups is to divide the viewing audience into a specific number of types (i.e., 5) with the ads are targeted to those different subscriber types. Alternatively, a specific number of ad types (representing intended target markets) are identified and the subscriber base is partitioned such that each subscriber (or group of subscribers) is associated with one of these ad types by correlating subscriber traits with the intended target market traits. The subscriber and ad types may be based on demographics, transaction characteristics, interests, other known criteria, or some combination thereof.

According to one embodiment, the assignment of subscribers to groups (whether based on ad type of subscriber type) is performed by correlating demographic data provided by third parties, such as by MicroVision, a product of Claritas, Inc. of San Diego, Calif. that provides demographic segment statistical information for market segments defined by ZIP+4 (approx. 10-15 households). The groups are formed by correlating each segment with an ad type or with each other segment and including each segment with the ad type or other segments that it is most similar to. If the correct number of groups are not formed or if the groups do not include enough subscribers, the correlation thresholds may be changed or groups may be combined if they are similar to each other. The generation of groups based on demographics is defined in more detail in applicants' co-pending patent applications that have previously been incorporated by reference (but not admitted to be prior art) and identified by docket numbers T719-00, T741-10 and T741-10PCT.

According to another embodiment, the groups may be generated by grouping subscribers having similar viewing characteristics. The viewing characteristics are generated by monitoring subscriber interactions with the TV and processing the interaction transactions in order to identify specific traits associated with the subscriber. The viewing characteristics may include, but are not limited to, favorite channels, favorite genre, channel change rate, and dwell time. The characteristics may be broken out by day and day part. It should be noted that the viewer characterizations include no raw transaction data. The groups are formed by correlating each subscriber's viewing characteristics with either (1) an ad type defining viewing characteristics of an intended target market, or (2) with each other subscribers viewing characteristics. Each subscribers viewing characteristics is included with the ad type or other subscribers viewing characteristics that it is most similar to. The generation of viewing characteristics is defined in more detail in Applicants co-pending applications that have previously been incorporated by reference in their entirety (but not admitted to be prior art) and identified by docket numbers T702-00, T702-02, T702-04, T702-15, T703-00, T704-00, T704-01, T704-01PCT, T734-10, T741-10 and T741-10PCT.

For systems in which selective delivery of advertisements is used, the advertisements chosen for delivery can be delivered to the set-top in a low-bandwidth and relatively low-speed channel or in a high-bandwidth or high-speed channel. These channels can be dedicated to ad delivery or may be shared, providing delivery channels for other services. The low bandwidth method of delivery would require that the ads be delivered (or begin being delivered) significantly in advance of the ad presentation. Ads delivered via a high bandwidth channel could be delivered at or just prior to the time of presentation.

An example of such a dedicated channel is a broadcast high-bandwidth “ad channel.”A service provider (Digital Broadcast Satellite (DBS), cable, Switched Digital Video (SDV), Local Multipoint Distribution System/Multipoint Multichannel Distribution System (LMDS/MMDS) allocates and dedicates one or more “channels” of the system to be used for delivering advertisements. This channel, used for transporting ads, would be a high bandwidth (e.g., 6 MHz) channel, and would, in one embodiment, carry nothing but ads. In one embodiment, the operator would determine which ads were sent, but essentially ads would be continually sent to the STB, the STB being able to store, for subsequent display. The appropriate ads carried on this channel would be encoded and transported in the same way that the other programming content (on other channels) was encoded and transported. That is, if one were to “tune” to the ad channel, one would receive conventional advertisements (normal video and audio), but only advertisements.

In the case of analog video, the ads would be transmitted just as analog video is transmitted over the network. In the case of digital video, the ad would be encoded and transported in the same way as conventional programming. A 6 MHz channel could carry several digital ad channels just as several digital video channels are carried within one 6 MHz channel. Moreover, other services (e.g., data) could be carried in the ad channel with the ads if desired.

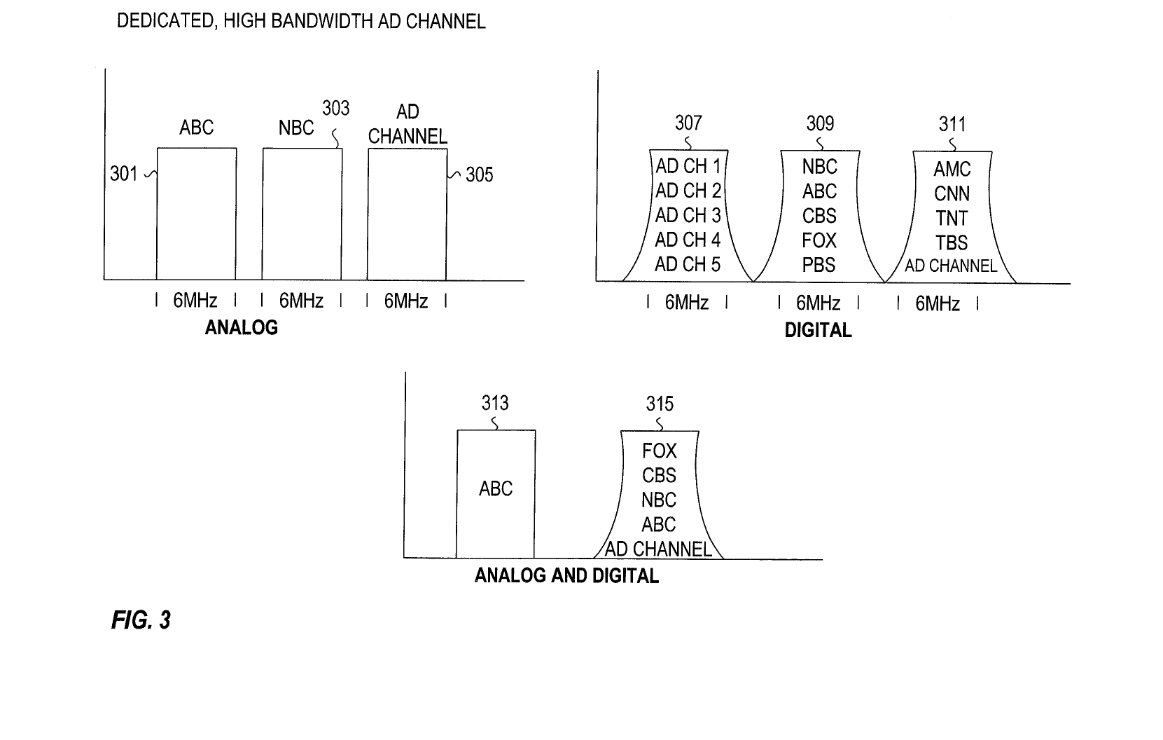

FIG. 3 shows several ways in which a high bandwidth ad channel could be transmitted, digitally or in analog form. As shown in FIG. 3, a conventional analog dedicated 6 MHz channel 305 may be used to carry advertisements. Generally, the ad channel in this instance is a 6 MHz digital channel transmitted along with the programming, e.g., ABC (301), NBC (303).

One or more ad channels may be carried within a 6 MHz digital channel. FIG. 3 shows a contiguous sequence of five advertisement channels within a dedicated digital ad channel 307. The digital ad channel 307 may be transmitted along with a digital programming channel 309. Furthermore, multiple digital ad channels may be carried within one 6 MHz digital channel and carried along with the programming (311).

Alternatively, a mixture of analog and digital may be chosen, e.g., an analog channel 313 may be used to carry programming and a digital channel 315 may be used to carry programming as well as the ad channel.

Ads can also be delivered to the STB via low and medium bandwidth channels as well and in a variety of formats (e.g., streaming media, MPEG-2, etc.) and protocols (ATM, IP, etc.) as will be evident to those skilled in the art.

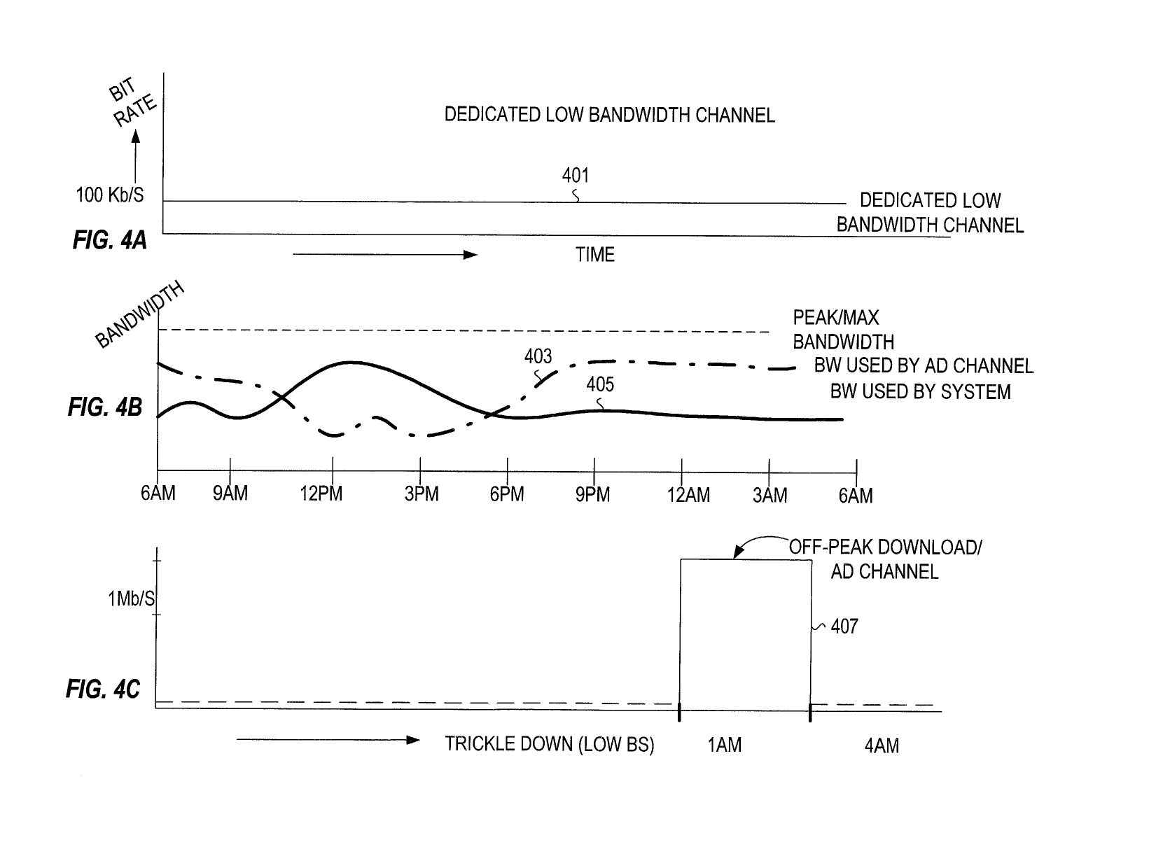

FIGS. 4A-4C illustrate ad channels being sent on low-moderate bandwidth channels, both at constant bit rates and variable bit rates. As shown in FIG. 4A, an example of such low bandwidth channels would be a dedicated channel 401 in which the advertisements are continually sent but at a low bit rate, and ultimately stored as a complete advertisement file on the STB. In FIG. 4A, the time is shown at the X axis, and the bit rate is shown on the Y axis.

Another approach is the “trickle down” approach that allows ad delivery to the STB without requiring a dedicated high bandwidth ad channel, such a high bandwidth channel being available for other services (e.g., network programming).

In this scenario, network bandwidth demand (or bandwidth demand by one or more individual subscribers) is monitored in real-time or statistically predicted. As shown in FIG. 4B, the ad channel is delivered at a varying bit rate following the bandwidth demands of the system. For example, as bandwidth demanded by the system channel increases, the bandwidth allocated for transmitting the ad channel would proportionally reduce. Similarly, when the bandwidth demand for the system channel decreases, the available bandwidth for carrying the ad channel is increased. FIG. 4B illustrates a varying bandwidth ad channel 403 which is shown to fluctuate. Generally, ad channel 403 varies based on the bandwidth used by the system channel 405. If the system channel (carrying programming and default advertisements) consumes more bandwidth, the bandwidth available to the ad channel is reduced. The sum of the ad channel bandwidth and the system channel bandwidth cannot exceed the maximum available. Such variable bit rate transmission schemes are well known to those skilled in the art.

Alternatively, one or more advertisements may be delivered at “off-peak” times (i.e., when the overall demand for bandwidth is comparatively low) and may be stored in the memory of the set-top box. In this embodiment, bandwidth usage can be monitored and statistically predicted, either for the entire network, a sub-portion of the network, or an individual subscriber. By anticipating or predicting a period of decreased bandwidth demand (either network-wide or individually), the advertisement delivery would coincide with such decreased demand. Such a scenario would allow operators to conserve bandwidth during “peak” times for other services. In off-peak download, the ad channel can operate at comparatively high bandwidth. FIG. 4C illustrates an off-peak download ad channel 407. It is to be noted that the off-peak download ad channel can be a medium to high bandwidth channel.

The methods described are applicable to, among others LMDS/MMDS, DBS, digital and analog hybrid fiber coax (HFC) cable TV, and SDV platforms.

At the subscriber end, the subscriber equipment, e.g., STB or PVR receives different advertisements and stores them in the memory. In accordance with the principles of the present invention, the client application residing at the subscriber end creates an advertisement guide, wherein the advertisement guide provides a list of available advertisements.

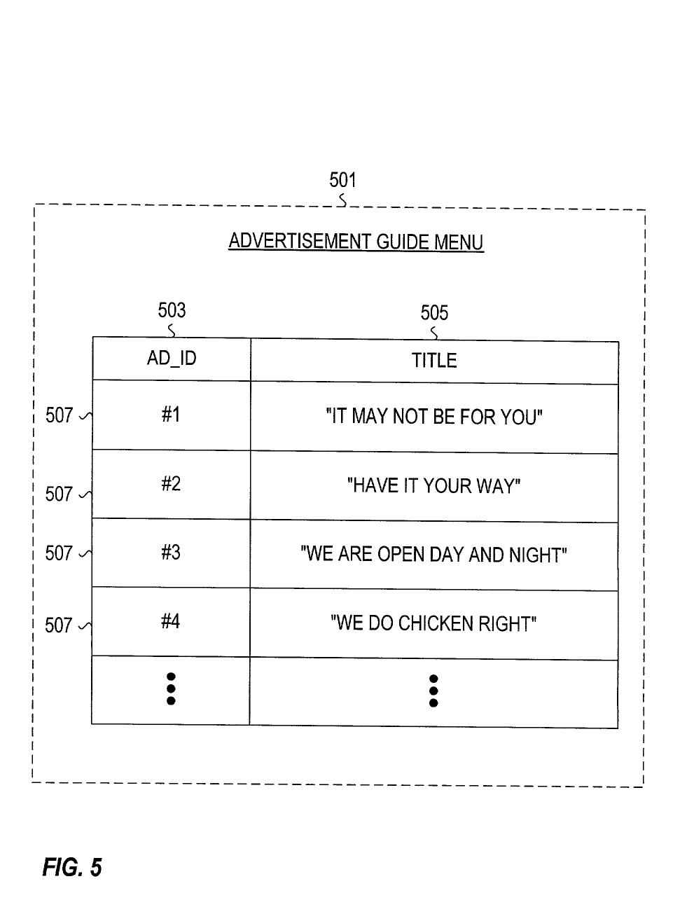

The advertisement guide may list the advertisements in a variety of manners. FIG. 5 illustrates an exemplary menu 501 wherein the advertisements are identified by unique identifications (AD_IDs) and their titles. For exemplary purposes, the menu 501 comprises two columns, a first column 503 for AD_ID, and a second column 505 for titles. Different AD_IDs and their corresponding titles are illustrated in the form of different rows 507.

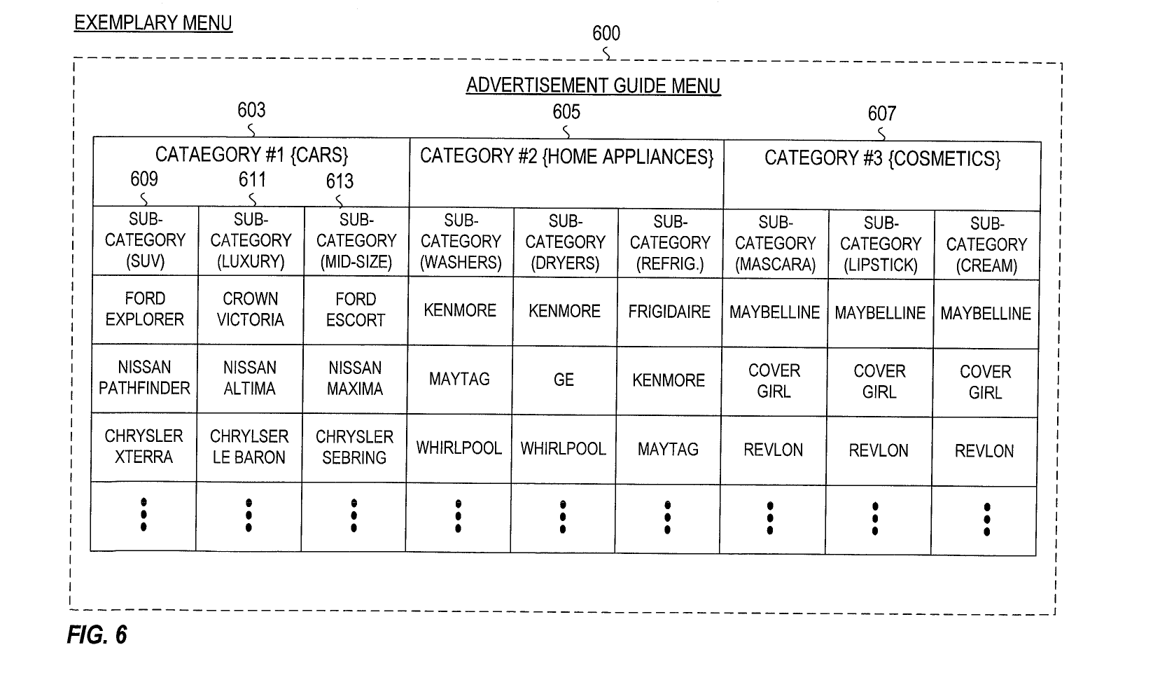

Alternatively, the advertisement guide may list the advertisements via different categories. For illustrative purposes, FIG. 6 illustrates another exemplary menu 600. In this menu, the advertisements are listed in different categories. For exemplary purposes, three different categories, cars 603, home appliances 605 and cosmetics 607 are shown. Within the categories, different subcategories may also be added. For example, the category for cars 603 comprises the different subcategories of Sport Utility Vehicles (SUVs) 609, luxury cars 611, and mid-size cars 613. Within each subcategory, a list of different advertisements is also provided, e.g., under the subcategory of SUV, the list includes advertisements for the Ford Explorer, the Nissan Pathfinder, and the Chrysler Xterra.

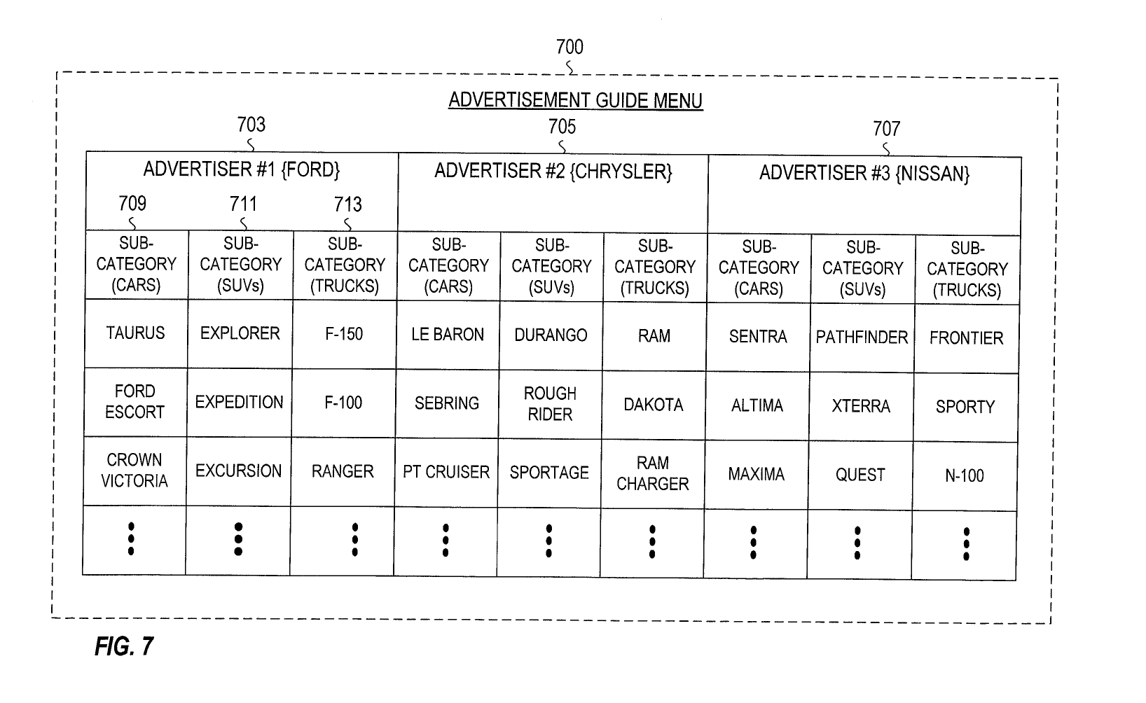

Furthermore, the advertisements may be listed via different advertisers. FIG. 7 illustrates another exemplary menu. In this embodiment, the advertisements are sorted via different advertisers. For exemplary purposes, the advertisement guide menu 700 lists three different advertisers. Advertiser #1 703 corresponds to Ford, advertiser #2 705 corresponds to Chrysler, and advertiser #3 707 corresponds to Nissan. For each advertiser, a plurality of subcategories is also defined. For advertiser 703, three different subcategories are shown, cars 709, SUVs 711, and trucks 713. Each subcategory may also comprise a list of available advertisements.

It is to be noted that FIGS. 5, 6, and 7 only illustrate exemplary menus. Other menus to assist the subscriber in their selection of different advertisements may also be provided. The display of available advertisements can be based on the market segment which has been determined to be appropriate for the subscriber (market segment based menuing). Alternatively, the subscriber may be presented with a set of market segments descriptions and asked to select one. In this way, a couple with a new child may themselves select the “growing family” market segment and will thus be presented with lists of advertisements which are appropriate for them.

These menus may be based on various different types of graphical user interfaces. Alternatively, XML or java-based applications may be used. The purpose of these menus is to provide a user-friendly interface to the subscriber.

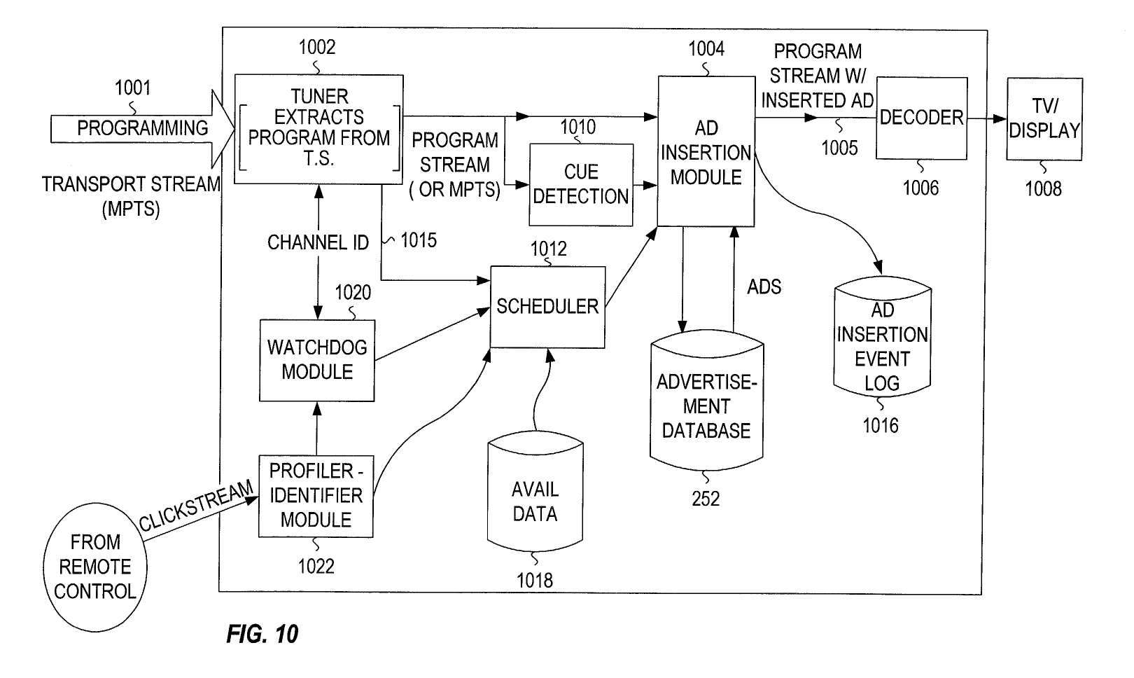

Once the subscriber selects an advertisement for display, the processor (e.g., SCU/processor 204 of FIG. 2) retrieves the contents and transmits the contents of the selected advertisement for display. Alternatively, the processor may schedule the display of the selected advertisement by inserting the selected advertisement in the next avail. The insertion of the advertisement in the avail is explained with reference to FIG. 10 and related text.

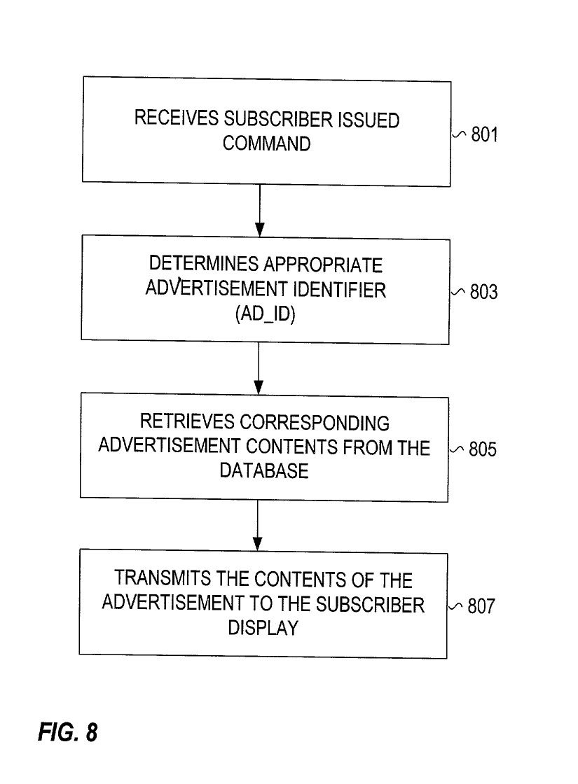

FIG. 8 illustrates the functionality associated with one embodiment of the present invention. In step 801, the processor recognizes the subscriber issued command, i.e., the advertisement selected by the advertiser. In step 803, the corresponding advertisement identification (AD_ID) is determined. In step 805, the processor retrieves the corresponding advertisement from the advertisement database. In step 807, the processor transmits the contents of the selected advertisement to the subscriber display, wherein the contents of the selected advertisements are immediately displayed to the subscriber.

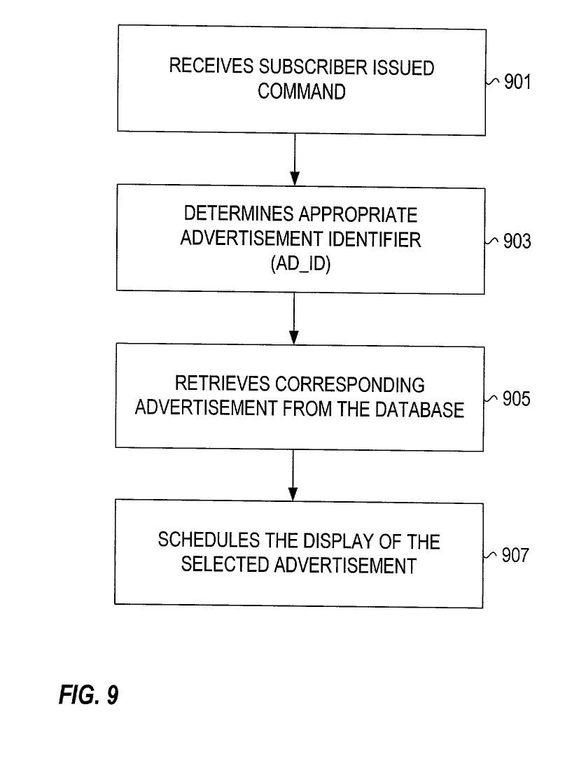

FIG. 9 illustrates the functionality associated with another embodiment of the present invention. At step 901, the processor receives a subscriber issued command, e.g., the selection of a particular advertisement by the subscriber. In step 903, the processor determines the identity of the corresponding advertisement. In step 905, the processor retrieves the corresponding advertisement from the advertisement database. In step 907, the processor schedules the display of the selected advertisement. Subsequently, the contents of the selected advertisement are inserted in the next available avail. If the subscriber selected more than one advertisement, the advertisements are inserted for the next few identified avails, the number of identified avails being equal to the number of selected advertisements.

In a simplest embodiment of the invention, the advertisements are inserted in the avails in the channel to which the STB is tuned. Such insertion functionality is applicable for SDV, cable-based, as well as LMDS/MMDS systems. In another embodiment, the ads are displayed in the avails in accordance with an algorithm that takes into account both the order of the advertisements and the duration of the avail relative to the duration of the ads identified in the queue such that the duration of the advertisement(s) inserted into the avail match the duration of the avail.

It should be apparent to those of skill in the art that there are many alternate embodiments for the insertion and display of the advertisement. Technologies for inserting data such as advertisements into other data streams are well known. In accordance with the invention, ads stored in digital format could be readily inserted into digital video streams as well as analog video streams. Furthermore, the invention is not limited to insertion of ads but can apply to any form of data and also is not limited to television but can be used to insert any information into any entertainment or data stream.

FIG. 10 is a functional block diagram illustrating advertisement insertion according to one embodiment of the present invention. In this example, the received programming stream 1001 is in the form of a DVB transport stream, i.e., a multiple program transport stream (MPTS). In the tuner function 1002, the channel selected by the subscriber is extracted and demodulated from the MPTS. This channel carries digital cue tones, which are detected by a cue detection module 1010. The advertisement to be inserted in the next detected avail has already been retrieved, e.g., from the scheduler 1012 using the avail data and prioritization or other scheduling algorithm. The advertisement insertion module 1004 inserts or splices the advertisement according to the queue tone timing. The resulting program stream 1005 with the substituted advertisement is decoded by decoder module 1006 and sent to the television 1008 or other display device.

The advertisement insertion of the present invention can be combined with a time/program based set of rules in which case the ad to be presented is determined in part by the time-of-day program being watched or a combination thereof.

It also is possible to use a system such as described in applicant's co-pending U.S. patent applications previously incorporated herein by reference (but not admitted to be prior art) and identified as docket numbers T705-01 and T705-13, to determine who is watching the television and organize the queue based at least partially on that criterion. Other methods include the use of personal identification numbers (PINs) to determine who is viewing the television, or monitoring interaction with an Electronic Program Guide (EPG). By characterizing the household, it is possible to establish the most appropriate queues for each time of day.

Program based rules also may be used in conjunction with the queues to provide a combination of “linked” advertising and advertising in accordance with the concepts of the present invention. Using such a combination, the order of the advertisements may be varied depending upon the program being watched. This allows a particular advertiser to link to a certain program. In one embodiment, the advertisement is moved to the top of the queue when a particular program is being watched. In an alternate embodiment, program dependent lists can be created, such that there is a list for a program like “ER” and a different one for “Survivor”.

The scheduler 1012 is the retrieval circuit, which receives the instructions for organization of the advertisement in the memory and then organizes the advertisement in accordance with the received instructions. In this exemplary embodiment, the scheduler retrieves from a dedicated control channel 1015 in the media stream 1001. However, as previously noted, this is just one of many possible transport streams instructions. The scheduler also provides a schedule and notifies the advertisement insertion module 1004 of the schedule.

When the cue tone is detected by cue detection module 1010, the advertisement database 252 requests the appropriate advertisement from the advertisement database 252 which then sends the advertisement to the insertion module 1004. The advertisement insertion module then inserts the advertisement with the proper timing.

In this exemplary embodiment, the advertisements that are stored into the advertisement database 252 are received over a dedicated advertisement channel in the media stream. For instance, the scheduler 1012 may include circuitry for picking out the appropriate advertisements for the particular STB from a continuous stream of advertisements as previously described and writing them to the advertisement database 252. The avail data module 1018 provides information about available avails (advertising opportunities). The watchdog module 1020 notifies the scheduler 1012 of any changes that may require a queue update or switching among multiple queues as previously described. For instance, a profiler-identifier module 1022 can process information such as data as to the program being watched and remote control operation, such as volume control and channel change control, to attempt to determine which particular viewer in a subscriber household is viewing the television in order to choose among the various queues as previously described.

The advertisement insertion module 1004 generates and stores an advertisement insertion event log 1016 of all insertion events. This is essentially the schedule of the ads inserted and whether or not they were inserted successfully and/or displayed. The insertion logs will eventually be sent upstream to the central office to be used for billing advertisers based on the ads that have been played at each subscriber's location.

Since FIG. 10 is functional block diagram, the blocks in FIG. 10 do not necessarily correspond to separate hardware components, such as illustrated in FIG. 2. For exemplary purposes, however, blocks 252 and 1016 represent portions of memory and might correspond to any one of more of the memories 210, 212, 214 shown in FIG. 2. Functional blocks 1004, 1006, 1010, 1012, 1020, and 1022 represent processing steps and might correspond to the system control unit/processor 204 and the channel processing circuit 222 shown in FIG. 2. As processing steps, these blocks may correspond to software executed by any form of digital processor in the system control unit. However, any one or more of these functions could be performed by dedicated hardware (e.g., an analog circuit) within the system control unit or separate therefrom. It should be understood that the term circuit as used in this specification is intended to be all-inclusive and to encompass analog circuits and digital circuits, including finite state machines, digital signal processors, computers, central processing units, ASICs, and programmed general purpose processors. Functional block 1002 corresponds to one or more of tuner block 218, demodulator block 220 and demultiplexer block 224 in FIG. 2.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, are within the spirit and scope of the invention. Accordingly, the foregoing description is by way of example only, and not limiting. The invention is limited only as defined in the following claims and equivalents thereto.

What is claimed is:

1. A method for displaying and scheduling subscriber selected advertisements, the method comprising:
displaying an advertisement guide menu;
receiving a subscriber selection request for at least one stored advertisement; and
scheduling the at least one stored advertisement for presentation.

2. The method of claim 1, further comprising presenting the at least one stored advertisement to the subscriber.

3. The method of claim 2, wherein said scheduling includes scheduling the at least one stored advertisement on-demand and said presenting includes immediately presenting the at least one stored advertisement.

4. The method of claim 1, wherein said scheduling includes placement of the at least one stored advertisement in an upcoming avail.

5. A system for displaying and scheduling subscriber selected advertisements, the system comprising:
a storage mechanism for storing advertisements;
an advertisement guide menu for displaying a plurality of advertisement descriptors;
a scheduling system for receiving at least one subscriber selection for at least one advertisement; and
a video presentation and playback module for presenting the at least one advertisement.

6. The system of claim 5, wherein the storage mechanism is part of a Personal Video Recorder (PVR).

7. The system of claim 5, wherein the storage mechanism is a part of a Video on Demand (VoD) system.

8. A method for targeting advertisements in an on-demand environment, the method comprising:
storing a plurality of advertisements;
targeting a set of advertisements through selective display of advertisement descriptors in an advertisement guide menu;
receiving a subscriber selection request for at least one stored advertisement; and
scheduling the at least one stored advertisement for presentation.

9. The method of claim 8, wherein said targeting includes using at least one market segmentation technique to determine which advertisements to selectively display in the advertisement guide menu.

10. The method of claim 8, wherein said targeting includes monitoring subscriber selections to determine the set of advertisements to selectively display in the advertisement guide menu.

11. A method for targeting advertisements in an on-demand environment, the method comprising:
selecting advertisements for storage, wherein the selecting is based upon use of at least one market segmentation technique;
displaying advertisement descriptors in an advertisement guide menu;
receiving a subscriber selection request for at least one stored advertisement; and
scheduling the at least one stored advertisement for presentation.

12. A system for targeting advertisements in an on-demand environment, the system comprising:
an interface for receiving advertisements;
a processor for selectively determining which advertisements are to be stored for subsequent display and for placing the advertisements in one or more market segments;
an advertisement guide menu for displaying a plurality of advertisement descriptors;
a user interface for receiving at least one subscriber selection for at least one advertisement; and
a video presentation and playback module for presenting the at least one advertisement.
